(19) United States
(12) Patent Application Publication
(10) Pub. No.: US 2004/0044476 A1
(43) Pub. Date: Mar. 4, 2004

(54) Environmental assessment system and method thereof

(75) Inventors: Shigeyuki Miyamoto, Tokyo (JP); Hiroo Harada, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/653,070

(22) Filed: Sep. 3, 2003

(30) Foreign Application Priority Data
Sep. 4, 2002 (JP) 2002-258850

(51) Int. Cl. G06F 19/00; G01V 7/00; G01V 3/00

(52) U.S. Cl. 702/2; 700/97

(57) ABSTRACT

The environmental assessment system includes a first input unit 1 and a second input unit 3 for respectively inputting types of activities and quantities of activities related to a reference system and a targeted system. The first storing unit 2 stores the data inputted by the first input unit 1 and the second storing unit 4 stores the data inputted by the second input unit 3. The third storing unit 5 stores environmental impact information including “environmental impact value per unit” for each activities of the reference system and the targeted system. The environmental impact assessment unit 6 calculates total environmental impact value exhausted by the reference system and the targeted system based on data stored in the first storing unit 2, the second storing unit 4, and the third storing unit 5. The output unit 7 outputs inputted data inputted by the first input unit 1 or the second input unit 3, or the total environmental impact value calculated by the environmental impact assessment unit 6.

This application is based on Japanese patent application NO.2002-258850, the content of which is incorporated hereinto by reference.

### BACKGROUND OF THE INVENTION

1. Field of the Invention

The present invention relates to an environmental assessment system for assessing environmental impact exhausted by a product or a system, and a method thereof, more specifically to an environmental assessment system for assessing environmental impact exhausted by a product or a system including hardware and software, and a method thereof.

2. Background of the Invention

In light of conservation of global environment, assessment of environmental impact exhausted by products such as commercial products or systems and reduction of such the impact have become more necessary these days.

In order to reduce the environmental impact exhausted by the products, it is necessary to design a product with taking the environmental impact exhausted by the product through its lifecycle, from manufacturing to disposal, into consideration. Therefore, it is necessary to quantify the environmental impact exhausted by the product through its lifecycle. Accordingly, an LCA (Life Cycle Assessment) has been studied, in which environmental impact of the product is assessed through its lifecycle.

Conventionally, there is disclosed an environmental assessment system based on the LCA in Japanese laid-open patent application No. Hei-7-311760.

FIG. 13 shows a block diagram of a conventional environmental assessment system. The environmental assessment system includes an input unit 41 that inputs data necessary for calculating environmental impacts exhausted by a product, a data storing unit 42 that stores the inputted data, an environmental impact assessment unit 43 that calculates total environmental impact value exhausted by the product, and an output unit 44 that outputs the total environmental impact value calculated by the environmental impact assessment unit 43. The output unit 44 may be a display and displays the inputted data or the total environmental impact value.

The input unit 41 inputs, for example, information relating to the contents of each processes operated through life cycle of a product, information relating to inter-relationships between respective processes, information relating to details of environmental impacts exhausted in each processes, and information on factors of environmental impacts that occur in each retails.

The data storing unit 42 stores the information, the item, and the environmental impact inputted by the input unit 41.

The environmental assessment unit 43 calculates the total environmental impacts of the product with the calculation being based on the interrelationships between the respective processes stored in the data storing section 42 and using the environmental impact values that occur in each of the processes.

Furthermore, it is disclosed in Japanese laid-open patent application No. Hei-9-16663 that the environmental assessment system shown in FIG. 13 further includes a image data storing unit. Therefore, the user can easily understand each processes operated through life cycle of a targeted product and reduce mistakes in inputting data.

Furthermore, it is disclosed in Japanese laid-open patent application No. Hei-11-353384 that the system includes an environmental impact assessment unit and a plurality of storing units each of which stores information related to environmental impacts. In this system, the storing units are distributed at places where the information related to environmental impacts are calculated. Thus, such the information are easily stored in the storing units.

Furthermore, in Japanese laid-open patent application No. 2001-357171, a method for calculating environmental impacts of a recycled product is disclosed. In this method, an environmental impact of a new part and a recycled part used in manufacturing process of recycled products are used for the calculation.

However, in the conventional environmental assessment system, it is complicated to calculate environmental impacts of a targeted system, for example a new system to be introduced, by comparing those of a reference system, for example an original system.

Usually, the environmental assessment system is designed to assess environmental impacts of same types of products or systems. For example, the reference system may be an old model computer and the targeted system may be a new model computer. In another case, when a user is a company manufacturing telephones, the reference system may be a telephone manufactured by a competitor and the targeted system may be a telephone manufactured by the company.

However, in order to assess and compare environmental impacts of the reference system and the targeted system by the conventional environmental assessment system, the following processes are necessary. Firstly, the user has to input data necessary for calculating the environmental impacts of the reference system to the environmental assessment system. Then, the environmental assessment system calculates the total environmental impact value of the reference system. Then, the user has to input data necessary for calculating the environmental impacts of the targeted system to the environmental assessment system. Then, the environmental assessment system calculates the total environmental impact value of the targeted system. Finally, the environmental assessment system compares the total environmental impact values of the environmental impacts of the reference system and the targeted system.

In such the case when the environmental system assesses environmental impacts of same types of products, data necessary for calculating the environmental impacts of the reference system and the targeted system may be partly same or similar to each other. However, as described above, in the conventional environmental assessment system, data necessary for calculating the environmental impacts of the reference system and the targeted system are separately inputted. Thus, the user cannot input the data in parallel.

Furthermore, in the conventional environmental assessment system, it is complicated to run processes for assessing environmental impacts of a system including hardware and software.

As for the system including hardware and software, various kinds of factors should be considered to calculate the environmental impacts thereof.

### SUMMARY OF THE INVENTION

Accordingly, an object of the present invention is to provide an environmental assessment system, a method, or a program capable of evaluating improvement of environmental impact easily and precisely when introducing a new product or a system instead of a previous product or a system.

According to the present invention, there is provided an environmental assessment system for assessing environmental impacts by comparing total environmental impact values exhausted by a reference system and a targeted system. The environmental assessment system comprises a first input unit that inputs information about the reference system; a first information storing unit that stores the information inputted by the first input unit; a second input unit that inputs information about the targeted system; a second information storing unit that stores the information inputted by the second input unit; a third information storing unit that stores information about environmental impact value per unit; a calculation unit that calculates total environmental impact values of the reference system and the targeted system based on the information stored in the first information storing unit, the second information storing unit, and the third information storing unit; and an output unit that outputs the environmental impact values of the reference system and the targeted system.

According to the present invention, as the environmental assessing system includes input unit for both of the reference system and the targeted system, the user can input information about the reference product and the targeted product easily.

The first input unit may include a first additional input unit that inputs information about consumption of electric power expensed by the reference system, and the second input unit may include a second additional input unit that inputs information about consumption of electric power expensed by the targeted system.

The first input unit may include a third additional input unit that inputs information about consumption of papers expensed by the reference system, and the second input unit may include a fourth additional input unit that inputs information about consumption of papers expensed by the targeted system.

The first input unit may include a fifth additional input unit that inputs information about movement of people related to the targeted system, and the second input unit may include a sixth additional input unit that inputs information about movement of people related to the reference system.

The first input unit may include a seventh additional input unit that inputs information about transportation properties related to the targeted system, and the second input unit may include a eighth additional input unit that inputs information about transportation properties related to the reference system.

The first input unit may include a ninth additional input unit that inputs information about network services related to the targeted system, and the second input unit may include a tenth additional input unit that inputs information about network services related to the reference system.

The first input unit may include a eleventh additional input unit that inputs information about devices or parts to be disposed of related to the targeted system, and the second input unit may include a twelfth additional input unit that inputs information about devices or parts to be disposed of related to the reference system.

The first input unit may include a eleventh additional input unit that inputs information about amount of devices or parts to be reserved related to the targeted system, and the second input unit may include a twelfth additional input unit that inputs information about amount of devices or parts to be reserved related to the reference system.

Conventionally, it was complicated and difficult to input various information related to activities and operations of a system product. According to the present invention, as the environmental assessing system includes various additional input units as described above, users are capable of inputting those various information simply and easily.

According to the present invention, there is provided a method of assessing environmental impacts by comparing total environmental impact values exhausted by a reference system and a targeted system. The method comprises the steps of: inputting information about the reference system and information about the targeted system in parallel; storing the information about the reference system and the information about the targeted system separately; calculating total environmental impact value of the reference system based on the information about the reference system and information about environmental impact value per unit that is previously stored; and calculating total environmental impact value of the targeted system based on the information about the targeted system and the information about environmental impact value per unit.

The method may further comprise the step of displaying the total environmental impact value of the reference system and the total environmental impact value of the targeted system in parallel at a same time.

The information about the reference system and the information about the targeted system may respectively include information about amount of consumption of electric power.

The information about the reference system and the information about the targeted system may respectively include information about amount of consumption of papers.

The information about the reference system and the information about the targeted system may respectively include information about movement of people.

The information about the reference system and the information about the targeted system may respectively include information about transportation properties.

The information about the reference system and the information about the targeted system may respectively include information about network services.

The information about the reference system and the information about the targeted system may respectively include information about devices to be disposed of.

The information about the reference system and the information about the targeted system may respectively include information about devices to be reserved.

The information about the reference system and the information about the targeted system may respectively include at least two of information selected from information about amount of consumption of electric power, information about amount of consumption of papers, information about movement of people, information about transportation properties, information about network services, information about devices to be disposed of, and information about devices to be reserved.

According to the present invention, there is provided a program to be executed by a computer for assessing environmental impacts by comparing total environmental impact values exhausted by a reference system and a targeted system. The program comprising the steps of: accepting inputting of information about the reference system, accepting inputting of information about the targeted system, storing the information about the reference system, storing the information about the targeted system, obtaining information about environmental impact value per unit, calculating total environmental impact value of the reference system based on the information about the reference system and the information about environmental impact value per unit; and calculating total environmental impact value of the targeted system based on the information about the targeted system and the information about environmental impact value per unit.

The program may further comprise the step of displaying the total environmental impact value of the reference system and the total environmental impact value of the targeted system in parallel at a same time.

According to the present invention, there is provided an environmental assessment system, a method thereof, and a program capable of evaluating improvement of environmental impact easily and precisely when introducing a new product or a system instead of a previous product or a system.

As the environmental assessment system separately includes a first input unit and a first storing unit for a reference product or a system, and a second input unit and a second storing unit for a targeted product or a system, users are capable of inputting data necessary for calculating environmental impact values for the reference product and the targeted product in parallel at a same time. Therefore, improvement of environmental impact is easily and precisely evaluated when introducing a targeted product or a system instead of a reference product or a system.

Furthermore, according to the present invention, there is provided an environmental assessment system, a method thereof, and a program capable of evaluating environmental impact value of a system including hardware and software easily and precisely.

As the environmental assessing system includes various additional input units as described above, users are capable of inputting those various information necessary for calculating environmental impact values exhausted by such the system including hardware and software, simply and easily.

It is to be noted that any arbitrary combination of the above-described structural components and expressions changed between a method, an apparatus, a system and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a block diagram of an environmental assessment system according to the first embodiment of the present invention.

FIG. 2 shows a block diagram of an environmental assessment system according to the second embodiment of the present invention.

FIG. 3 shows a block diagram of an example of the environmental assessment system shown in FIG. 2.

FIG. 4 shows a diagram of an example of an input display for inputting data in the environmental assessment system according to the second embodiment.

FIG. 5 shows a diagram of an example of an input display for inputting data in the environmental assessment system according to the second embodiment.

FIG. 6 shows a diagram of an example of an input display for inputting data in the environmental assessment system according to the second embodiment.

FIG. 7 shows a diagram of an example of an input display for inputting data in the environmental assessment system according to the second embodiment.

FIG. 8 shows a diagram of an example of an input display for inputting data in the environmental assessment system according to the second embodiment.

FIG. 9 shows a diagram of an example of an input display for inputting data in the environmental assessment system according to the second embodiment.

FIG. 10 shows a diagram of an example of an input display for inputting data in the environmental assessment system according to the second embodiment.

FIG. 11 shows a diagram of an example of an input display for inputting data in the environmental assessment system according to the second embodiment.

FIG. 12 shows a diagram of an example of an output display of the environmental assessment system according to the second embodiment.

FIG. 13 shows a diagram of a conventional environmental assessment system.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

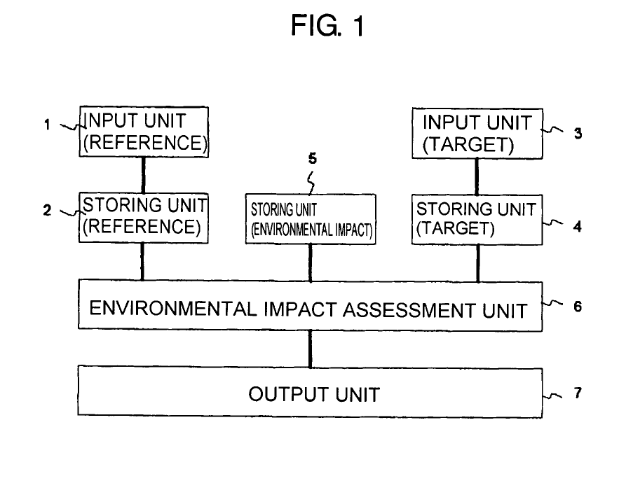

FIG. 1 shows an environmental assessment system according to the first embodiment of the present invention.

The environmental assessment system shown in FIG. 1 includes a first input unit 1, a first storing unit 2, a second input unit 3, a second storing unit 4, a third storing unit 5, an environmental impact assessment unit 6, and an output unit 7.

The first input unit 1 inputs types of activities and quantities of activities related to a reference system. The first storing unit 2 stores the data inputted by the first input unit 1. The second input unit 3 inputs types of activities and quantities of activities related to a targeted system. The second storing unit 4 stores the data inputted by the second input unit 3. The third storing unit 5 stores environmental impact information including “environmental impact value per unit” for each activities of the reference system and the targeted system.

The environmental impact assessment unit 6 calculates total environmental impact value exhausted by the reference system and the targeted system based on data stored in the first storing unit 2, the second storing unit 4, and the third storing unit 5.

The output unit 7 outputs inputted data inputted by the first input unit 1 or the second input unit 3, or the total environmental impact value calculated by the environmental impact assessment unit 6.

The operation of the environmental assessment system according to the first embodiment of the present invention will be explained in the following.

Firstly, the user of this system inputs a type of and quantity of activities of the reference system and the targeted system respectively via the first input unit 1 and the second input unit 3.

Then, the first storing unit 2 and the second storing unit 4 respectively store the data inputted via the first input unit 1 and the second input unit 3.

Then, the environmental impact assessment unit 6 calculates the total environmental impact value of the reference system based on the data stored in the first storing unit 2 and the “environmental impact value per unit” stored in the third storing unit 5. At the same time, the environmental impact assessment unit 6 calculates the total environmental impact value of the targeted system based on the data stored in the second storing unit 4 and the “environmental impact value per unit” stored in the third storing unit 5.

Finally, the output unit 7 displays the total environmental impact values of the reference system and the targeted system, calculated by the environmental impact assessment unit 6 in parallel at a same time.

The environmental assessment system separately includes a first input unit 1 and a first storing unit 2 for a reference system, and a second input unit 3 and a second storing unit 4 for a targeted system. Therefore, the environmental assessment system according to the present embodiment is capable of inputting data necessary for calculating environmental impact values of the reference system and the targeted system, which may be partly same or similar, at a dame time in parallel.

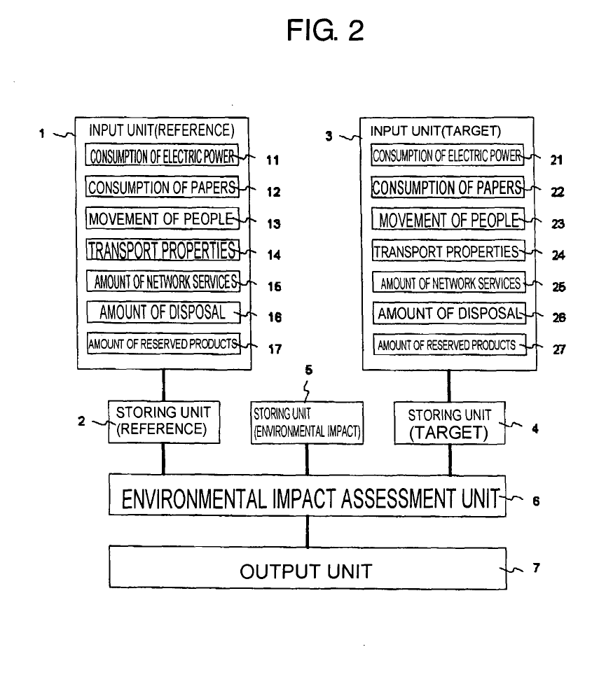

FIG. 2 shows a block diagram of an environmental assessment system according to the second embodiment of the present invention.

The environmental assessment system shown in FIG. 2 basically includes same elements included in the system of the first embodiment shown in FIG. 1 although the first input unit 1 and second input unit 3 are different from those shown in FIG. 1. Referring to FIG. 2, similar components to those illustrated in FIG. 1 referred to in the first embodiment are given the identical numerals, and description thereof shall be omitted as the case may be.

The first input unit 1 inputs types of activities and quantities of activities related to a reference system. The first input unit 1 includes an input unit 11 for inputting consumption of electric power, an input unit 12 for inputting consumption of papers, an input unit 13 for inputting movement of the people, an input unit 14 for inputting transport properties, an input unit for inputting amount of network services, an input unit 16 for inputting amount of devices or parts to be disposed of, and an input unit 17 for inputting amount of devices or parts to be reserved.

The second input unit 3 inputs types of activities and quantities of activities related to a reference system. The second input unit 3 includes an input unit 21 for inputting consumption of electric power, an input unit 22 for inputting consumption of papers, an input unit 23 for inputting movement of the people, an input unit 24 for inputting transport properties, an input unit 25 for inputting amount of network services, an input unit 26 for inputting amount of devices or parts to be disposed of, and an input unit 27 for inputting amount of devices or parts to be reserved.

The operation of the environmental assessment system according to the second embodiment of the present invention will be explained in the following.

Firstly, the user of this system inputs a type of and quantity of activities of the reference system and the targeted system respectively via the first input unit 1 and the second input unit 3.

The user may input the consumptions of electric power expensed by the reference system and the targeted system respectively via the input unit 11 and the input unit 21.

The user may input the consumptions of papers such as printer papers used by the reference system and the targeted system via the input unit 12 and input unit 22.

The user may input total amounts of movement of people such as employees related to activities of the reference system and the targeted system respectively via the input unit 13 and the input unit 23.

The user may input total amounts of transportation of packages or baggage related to the activities of the reference system and the targeted system respectively via the input unit 14 and the input unit 24.

The user may input total amounts of network services including networks such as telephone networks or Internet related to the activities of the reference system and the targeted system respectively via the input unit 15 and the input unit 25.

When the reference system or the targeted system are systems for stock control, the user may input total amounts of products to be disposed of related to the reference system and the targeted system respectively via the input unit 16 and the input unit 26. When the reference system or the targeted system are systems for stock control, the user may input total amounts of products to be reserved related to the reference system and the targeted system respectively via the input unit 16 and the input unit 26.

The first storing unit 2 and the second storing unit 4 respectively store the data inputted in the first input unit 1 and the second input unit 3.

Then, the environmental impact assessment unit 6 calculates the total environmental impact value of the reference system based on the data stored in the first storing unit 2 and the “environmental impact value per unit” stored in the third storing unit 5. At the same time, the environmental impact assessment unit 6 calculates the total environmental impact value of the targeted system based on the data stored in the second storing unit 4 and the “environmental impact value per unit” stored in the third storing unit 5.

Finally, the output unit 7 displays the total environmental impact values of the reference system and the targeted system, calculated by the environmental impact assessment unit 6 in parallel at a same time.

As described above, the first input unit 1 and the second input unit 3 of the environmental assessment system according to the second embodiment respectively includes, the input unit 11 or 21 for inputting consumption of electric power, the input unit 12 or 22 for inputting consumption of papers, the input unit 13 or 23 for inputting movement of the people, the input unit 14 or 24 for inputting transport properties, the input unit 15 or 25 for inputting amount of network services, the input unit 16 or 26 for inputting amount of devices or parts to be disposed of, and the input unit 17 or 27 for inputting amount of devices or parts to be reserved. Therefore, with this environmental assessment system, it is easy to input data necessary for calculating total environmental impact values of system products with taking all of the activities and operations of the system products into consideration.

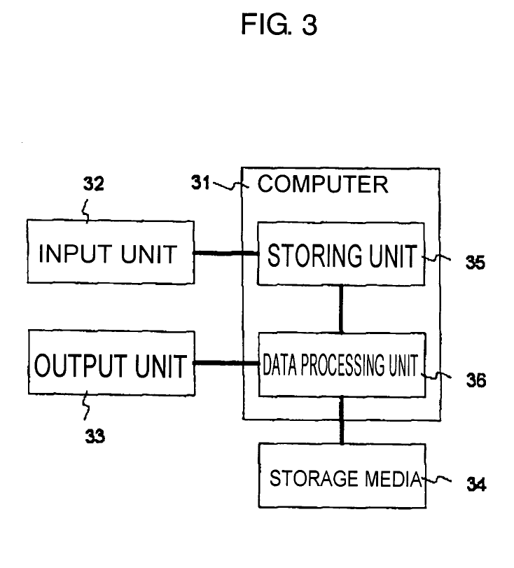

FIG. 3 shows a block diagram of an example of the environmental assessment system according to the present invention. The environmental assessment system includes a computer 31, an input unit 32, an output unit 33, and a storage media 34. The computer 31 includes a storing unit 35 and a data processing unit 36.

The input unit 32 may be a keyboard, a mouse, and so on, and corresponds to the first input unit 1 and the second input unit 3 shown in FIG. 2. The output unit 33 may be a display, a printer, and so on, and corresponds to the output unit 7 shown in FIG. 2. The storage media 34 may be a magnetic disk, an optical magnetic disk, and so on, and stores an assessment program that includes processing procedure for calculating total environmental impact values according to the present invention.

The data processing unit 36 reads the assessment program stored in the storage media 34. The storing unit 35 may be a hard disc and so on, and corresponds to the first storing unit 2, the second storing unit 4, and the third storing unit 5 shown in FIG. 2.

The data processing unit 36 may be a microprocessor and so on and corresponds to the environmental impact assessment unit 6 shown in FIG. 2. The data processing unit 36 executes the assessment program read out from the storage media 34.

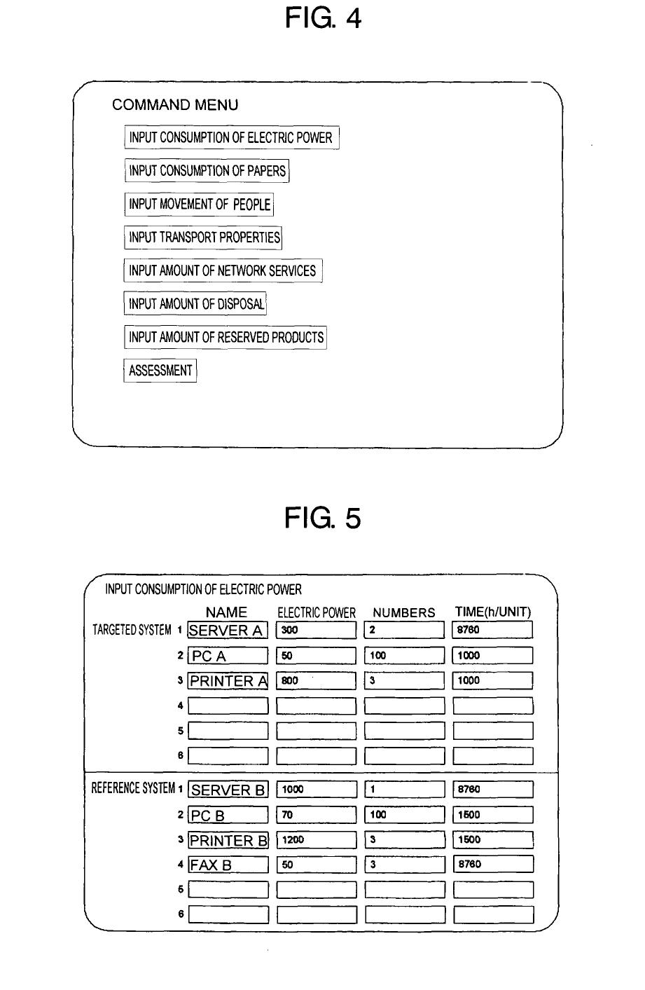

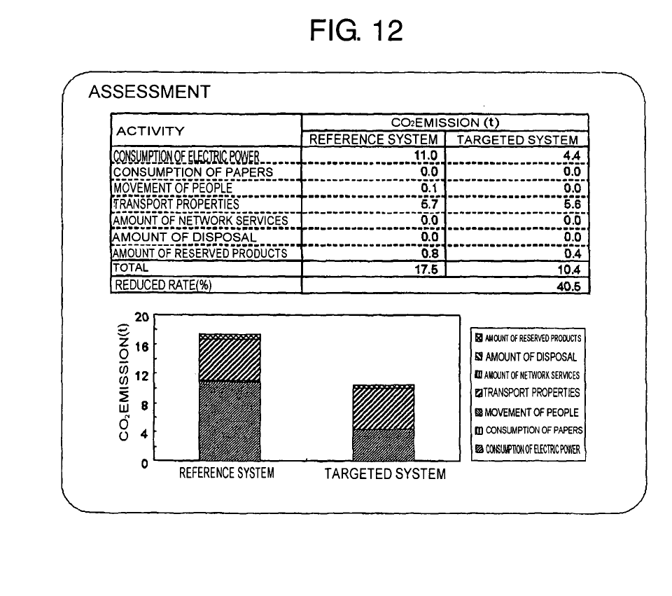

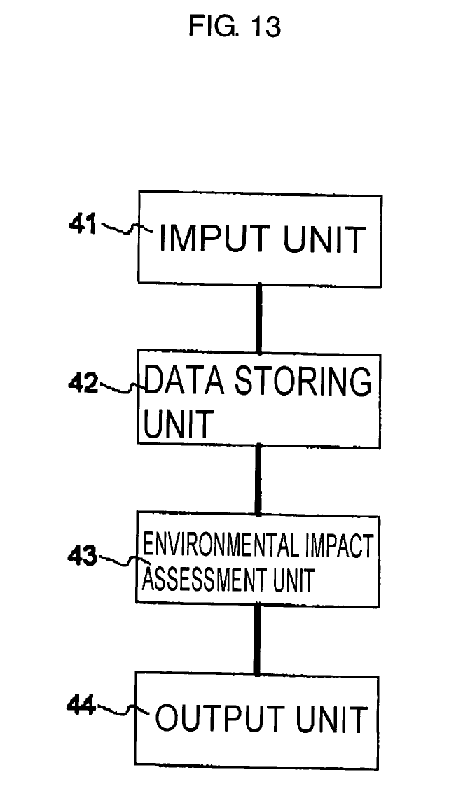

Then, examples of displays will be explained in the following. FIGS. 4 to 11 show examples of displays for inputting data necessary for calculating total environmental impact values of the reference system and the targeted system by the environmental assessment system according to the second embodiment of the present invention. FIG. 12 shows an example of a display that displays results calculated by the environmental assessment system according to the second embodiment of the present invention.

As shown in FIG. 4, the user can select one of the operations among “input consumption of electric power”, “input consumption of papers”, “input movement of the people”, “input transport properties”, “input amount of network services”, “input amount of disposal”, “input amount of reserved products”, and “environmental assessment” included in the display. The use may select one of the operations by clicking the desired operation by a mouse, for example.

When the user selects the “input consumption of electric power”, a display shown in FIG. 5 will be displayed. In this display, the upper half is an input unit for the targeted system, and the lower half is an input unit for the reference system. Each of the input units includes six rows. For each rows, there are four input sections for inputting “item name”, “consumption of electric power (W)”, “numbers of the item”, and “duration time (hours/unit)”. As for the input section for inputting “item name”, the user can input characters, and as for the input sections for inputting “consumption of electric power (W)”, “numbers of the item”, and “duration time (hours/unit)”, the user can input numerals.

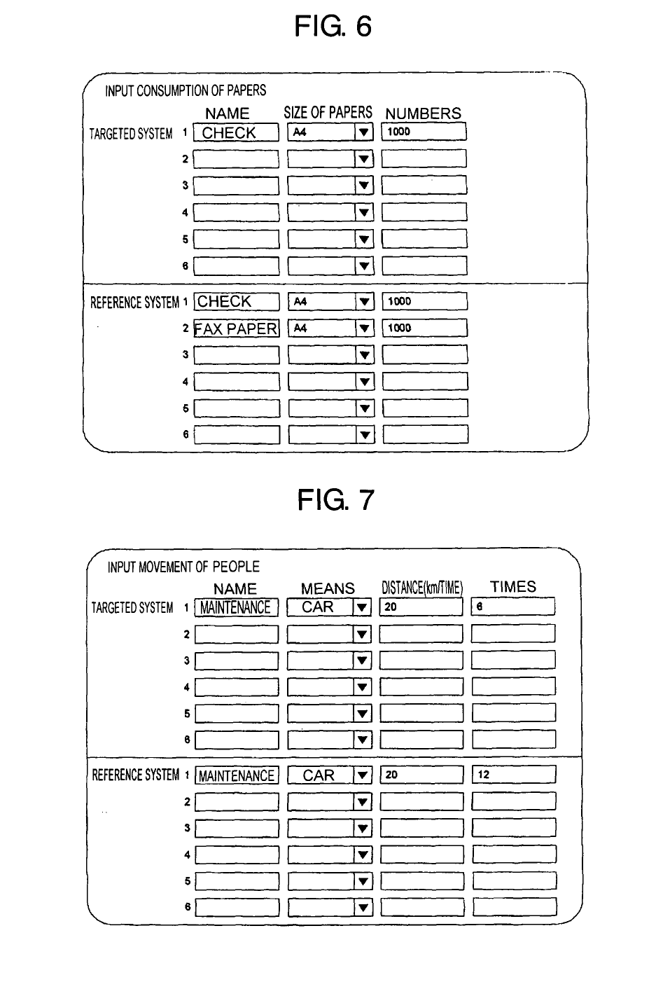

When the user selects the “input consumption of papers”, in the display shown in FIG. 4, a display shown in FIG. 6 will be displayed. In this display, the upper half is an input unit for the targeted system, and the lower half is an input unit for the reference system. Each of the input units includes six rows. For each rows, there are three input sections for inputting “item name”, “size of the papers”, and “numbers of the papers”. As for the input section for inputting “item name”, the user can input characters, and as for the input section for inputting “numbers of the papers”, the user can input numerals. As for the input section for inputting “size of the papers”, the user can select one of the size of the papers from “A3”, “A4”, “A5”, “B4”, “B5”, and so on, by using a scroll bar, for example.

When the user selects the “input movement of the people”, in the display shown in FIG. 4, a display shown in FIG. 7 will be displayed. In this display, the upper half is an input unit for the targeted system, and the lower half is an input unit for the reference system. Each of the input units includes six rows. For each rows, there are four input sections for inputting “item name”, “means for the movement”, “distance for the movement (km/time)”, and “times of the movement”. As for the input section for inputting “item name”, the user can input characters, and as for the input sections for inputting “distance for the movement” and “times of the movement”, the user can input numerals. As for the input section for inputting “means for the movement”, the user can select one of the means for the movement from “car”, “air plane”, “train”, “bus”, and so on, by using a scroll bar, for example.

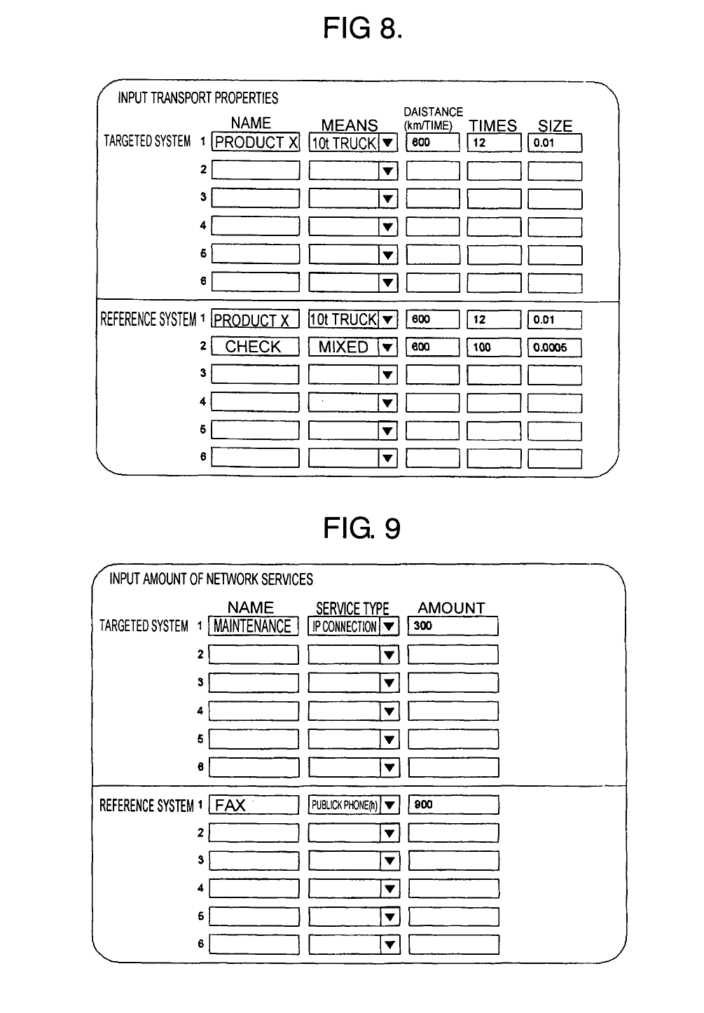

When the user selects the “input transport properties” or input amount of transportation of packages or baggage in the display shown in FIG. 4, a display shown in FIG. 8 will be displayed. In this display, the upper half is an input unit for the targeted system, and the lower half is an input unit for the reference system. Each of the input units includes six rows. For each rows, there are five input sections for inputting “item name”, “means for the transportation”, “distance for the transportation (km/time)”, “times of the transportation”, and “size (m³)”. As for the input section for inputting “item name”, the user can input characters, and as for the input sections for inputting “distance for the transportation”, “times of the transportation”, and “size (m³) ”, the user can input numerals. As for the input section for inputting “means for the transportation”, the user can select one of the means for the transportation from “10-ton truck”, “4-ton truck”, “2-ton truck”, “car”, “mixed” and soon, by using a scroll bar, for example.

When the user selects “input amount of network services”, in the display shown in FIG. 4, a display shown in FIG. 9 will be displayed. In this display, the upper half is an input unit for the targeted system, and the lower half is an input unit for the reference system. Each of the input units includes six rows. For each rows, there are three input sections for inputting “item name”, “type of the service”, and “amount”. As for the input section for inputting “item name”, the user can input characters, and as for the input sections for inputting “amount”, the user can input numerals. As for the input section for inputting “type of the service”, the user can select one of the type of the service from “public phone”, “IP connection”, “hosting”, and so on, by using a scroll bar, for example.

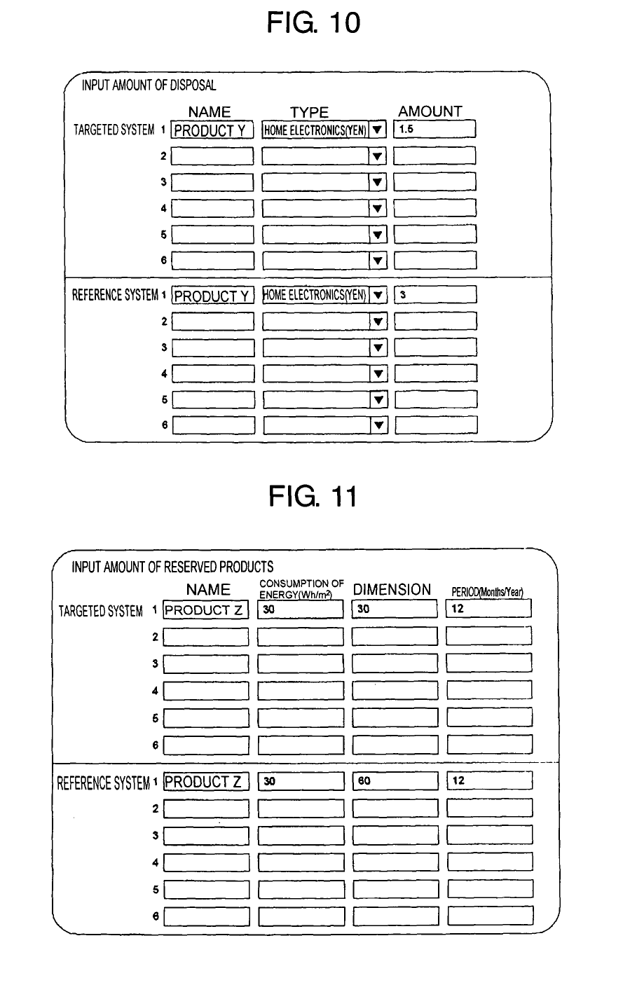

When the user selects “input amount of disposal” or input amount of devices or parts to be disposed of, in the display shown in FIG. 4, a display shown in FIG. 10 will be displayed. In this display, the upper half is an input unit for the targeted system, and the lower half is an input unit for the reference system. Each of the input units includes six rows. For each rows, there are three input sections for inputting “item name”, “type of the product to be disposed of”, and “amount”. As for the input section for inputting “item name”, the user can input characters, and as for the input section for inputting “amount”, the user can input numerals. As for the input section for inputting “types of the product to be disposed of”, the user can select one of the types of the product from “home electronics”, “computer”, and so on, by using a scroll bar, for example.

When the user selects “input amount of reserved products”, or input amount of devices or parts to be reserved, in the display shown in FIG. 4, a display shown in FIG. 11 will be displayed. In this display, the upper half is an input unit for the targeted system, and the lower half is an input unit for the reference system. Each of the input units includes six rows. For each rows, there are four input sections for inputting “item name”, “consumption of energy expensed at the ware house (Wh/m²)”, “dimension of the ware house (m²)”, and “period for reserving the devices or parts (months/year)”. As for the input section for inputting “item name”, the user can input characters, and as for the input sections for inputting “consumption of energy expensed at the ware house”, “dimension of the ware house”, and “period for storing the product”, the user can input numerals.

When the user selects “assessment”, in the display shown in FIG. 4, a display shown in FIG. 12 will be displayed. In this display, CO₂ emissions by each activities or operations of the reference system and the targeted system, such as “consumption of electric power”, “consumption of papers”, “movement of the people”, “transportation of packages or products”, “network services”, “disposal”, and “reserved products”, and total of the CO₂ emissions are displayed in a table and a graphical chart. Further, reduction rate of the CO₂ emissions for the targeted system/the reference system is shown.

An example of the operation of the environmental assessment system according to the second embodiment will be explained in the following.

Firstly, the user of the system selects one of the operations among “input consumption of electric power”, “input consumption of papers”, “input movement of the people”, “input transport properties”, “input amount of network service”, “input amount of disposal”, and “input amount of reserved products” included in the display shown in FIG. 4.

Then, one of the displays shown in FIGS. 5 to 11 will be displayed. Then, the user inputs data for the reference system and the targeted system in parallel.

After that, when the user selects “assessment” from the display shown in FIG. 4, the data processing unit 36 calculates the CO₂ emissions based on the inputted data. The calculated result is displayed as shown in FIG. 12.

The CO₂ emissions emitted by the consumption of electric power of the reference system and the targeted system are calculated in accordance with the following equation (1). Here, the data processing unit 36 uses the value of the “CO₂ emissions per unit” previously stored in the third storing unit 5.

(1) CO₂ emissions by consumption of electric power of a system [t]=Σ (consumption of electric power [W]*used hours [h]*number of the units*CO₂ emissions per unit [t/Wh] (where * means “times”)

The CO₂ emissions emitted by the consumption of papers in the reference system and the targeted system are calculated in accordance with the following equation (2). Here, the data processing unit 36 uses the value of the “CO₂ emissions per unit” for each size of the papers previously stored in the third storing unit 5.

(2) CO₂ emissions by consumption of papers in a system [t]=Σ(numbers of the papers used in the system*CO₂ emissions per paper of the size [t/number] (where * means “times”)

The CO₂ emissions emitted by the movement of people for the reference system and the targeted system are calculated in accordance with the following equation (3). Here, the data processing unit 36 uses the value of the “CO₂ emissions per unit” for each means of the movement previously stored in the third storing unit 5.

(3) CO₂ emissions by movement of people for a system [t]=Σ(distance [km/time]*times of the movement*CO₂ emissions per movement of the means [t/km] (where * means “times”)

The CO₂ emissions emitted by the transportation of products or packages of the reference system and the targeted system are calculated in accordance with the following equation (4). Here, the data processing unit 36 uses the value of the “CO₂ emissions per unit” for each means of the transportation previously stored in the third storing unit 5.

(4) CO₂ emissions by transportation of products of a system [t]=Σ(distance [km/time]*times of the transportation*size [m³]/capacity of the means for the transportation [m³]*CO₂ emissions per transportation of the means [t/km] (where * means “times”)

The CO₂ emissions emitted by the network service used in the reference system and the targeted system are calculated in accordance with the following equation (5). Here, the data processing unit 36 uses the value of the “CO₂ emissions per unit” for each services previously stored in the third storing unit 5.

(5) CO₂ emissions by network services used in a system [t]=Σ(amount*CO₂ emissions per unit of the service [t/km] (where * means “times”)

The CO₂ emissions emitted by the products to be disposed of for the reference system and the targeted system are calculated in accordance with the following equation (6). Here, the data processing unit 36 uses the value of the “CO₂ emissions per unit” for each type of products previously stored in the third storing unit 5.

(6) CO₂ emissions emitted by products to be disposed of for a system [t]=Σ(amount to be disposed of*CO₂ emissions per unit of the type [t/km] (where * means “times”)

The CO₂ emissions emitted by the reserved products for the reference system and the targeted system are calculated in accordance with the following equation (7). Here, the data processing unit 36 uses the value of the “CO₂ emissions per unit” for previously stored in the third storing unit 5.

(7) CO₂ emissions emitted by reserved products for a system [t]=Σ(consumption of energy expensed at the ware house [Wh/m²]*dimension of the ware house [m²]*period for reserving the product [month]/12*CO₂ emissions per unit [t/km] (where * means “times”)

The total of the CO₂ emissions emitted by the reference system and the targeted system are respectively calculated by adding the CO₂ emissions calculated in accordance with the above equation (1) to (7).

Although the present invention has been described by way of exemplary embodiments, it should be understood that many changes and substitutions may further be made by those skilled in the art without departing from the scope of the present invention which is defined by the appended claims.

What is claimed is:

1. An environmental assessment system for assessing environmental impacts by comparing total environmental impact values exhausted by a reference system and a targeted system, comprising:
a first input unit that inputs information about said reference system;
a first information storing unit that stores said information inputted by said first input unit;
a second input unit that inputs information about said targeted system;
a second information storing unit that stores said information inputted by said second input unit;
a third information storing unit that stores information about environmental impact value per unit;
a calculation unit that calculates total environmental impact values of said reference system and said targeted system based on said information stored in said first information storing unit, said second information storing unit, and said third information storing unit;
an output unit that outputs said environmental impact values of said reference system and said targeted system.

2. The environmental assessment system as set forth in claim 1, wherein said first input unit includes a first additional input unit that inputs information about consumption of electric power expensed by said reference system, and said second input unit includes a second additional input unit that inputs information about consumption of electric power expensed by said targeted system.

3. The environmental assessment system as set forth in claim 1, wherein said first input unit includes a third additional input unit that inputs information about consumption of papers expensed by said reference system, and said second input unit includes a fourth additional input unit that inputs information about consumption of papers expensed by said targeted system.

4. The environmental assessment system as set forth in claim 1, wherein said first input unit includes a fifth additional input unit that inputs information about movement of people related to said targeted system, and said second input unit includes a sixth additional input unit that inputs information about movement of people related to said reference system.

5. The environmental assessment system as set forth in claim 1, wherein said first input unit includes a seventh additional input unit that inputs information about transportation properties related to said targeted system, and said second input unit includes a eighth additional input unit that inputs information about transportation properties related to said reference system.

6. The environmental assessment system as set forth in claim 1, wherein said first input unit includes a ninth additional input unit that inputs information about network services related to said targeted system, and said second input unit includes a tenth additional input unit that inputs information about network services related to said reference system.

7. The environmental assessment system as set forth in claim 1, wherein said first input unit includes a eleventh additional input unit that inputs information about devices or parts to be disposed of related to said targeted system, and said second input unit includes a twelfth additional input unit that inputs information about devices or parts to be disposed of related to said reference system.

8. The environmental assessment system as set forth in claim 1, wherein said first input unit includes a eleventh additional input unit that inputs information about amount of devices or parts to be reserved related to said targeted system, and said second input unit includes a twelfth additional input unit that inputs information about amount of devices or parts to be reserved related to said reference system.

9. A method of assessing environmental impacts by comparing total environmental impact values exhausted by a reference system and a targeted system, comprising the steps of:
inputting information about said reference system and information about said targeted system in parallel;
storing said information about said reference system and said information about said targeted system separately;
calculating total environmental impact value of said reference system based on said information about said reference system and information about environmental impact value per unit that is previously stored;
calculating total environmental impact value of said targeted system based on said information about said targeted system and said information about environmental impact value per unit.

10. The method as set forth in claim 9, further comprising the step of displaying said total environmental impact value of said reference system and said total environmental impact value of said targeted system in parallel at a same time.

11. The method as set forth in claim 9, wherein said information about said reference system and said information about said targeted system respectively include information about amount of consumption of electric power.

12. The method as set forth in claim 9, wherein said information about said reference system and said information about said targeted system respectively include information about amount of consumption of papers.

13. The method as set forth in claim 9, wherein said information about said reference system and said information about said targeted system respectively include information about movement of people.

14. The method as set forth in claim 9, wherein said information about said reference system and said information about said targeted system respectively include information about transportation properties.

15. The method as set forth in claim 9, wherein said information about said reference system and said information about said targeted system respectively include information about network services.

16. The method as set forth in claim 9, wherein said information about said reference system and said information about said targeted system respectively include information about devices or parts to be disposed of.

17. The method as set forth in claim 9, wherein said information about said reference system and said information about said targeted system respectively include information about devices or parts to be reserved.

18. The method as set forth in claim 9, wherein said information about said reference system and said information about said targeted system respectively include at least two of information selected from information about amount of consumption of electric power, information about amount of consumption of papers, information about movement of people, information about transportation properties, information about network services, information about devices or parts to be disposed of, and information about devices or parts to be reserved.

19. A program to be executed by a computer for assessing environmental impacts by comparing total environmental impact values exhausted by a reference system and a targeted system, said program comprising the steps of:
accepting inputting of information about said reference system,
accepting inputting of information about said targeted system,
storing said information about said reference system,
storing said information about said targeted system,
obtaining information about environmental impact value per unit,
calculating total environmental impact value of said reference system based on said information about said reference system and said information about environmental impact value per unit;
calculating total environmental impact value of said targeted system based on said information about said targeted system and said information about environmental impact value per unit.

20. The program as set forth in claim 19, the program further comprising the step of displaying said total environmental impact value of said reference system and said total environmental impact value of said targeted system in parallel at a same time.
